(19) United States
(12) Patent Application Publication
(10) Pub. No.: US 2007/0274478 A1
(43) Pub. Date: Nov. 29, 2007

(54) SECURITY SYSTEM AND METHOD FOR LIMITING ACCESS TO PREMISES

(75) Inventor: George Crawford III, Royse City, TX (US)

Correspondence Address: HITT GAINES P.C., P.O. BOX 832570, RICHARDSON, TX, 75083, US

(73) Assignee: Open Options, Incorporated, Carrollton, TX (US)

(21) Appl. No.: 11/381,168

(22) Filed: May 2, 2006

(51) Int. Cl. H04M 11/00

(52) U.S. Cl. 379/100.05

(57) ABSTRACT

A remote station for a security system, a method of providing security and a security system incorporating at least one remote station. In one embodiment, the remote station includes: (1) a query unit configured to generate a query to a requestor regarding a reason for an attempt by said requestor to gain entry to particular premises and (2) a response recorder associated with said query unit and configured to receive a response to said query and cause said response to be stored.

### TECHNICAL FIELD OF THE INVENTION

The present invention is directed, in general, to security systems and, more particularly, to a security system and related method for limiting access to premises.

### BACKGROUND OF THE INVENTION

Security systems have become vital tools for protecting and limiting access to property. The most basic security systems involve mechanical locks that require keys to open. Anyone possessing the proper key can gain entry to locked premises at any time. Absent other entry detection means, no record of the entry is generated.

More sophisticated security systems involve electronic devices that read cards, tags or other identification media or scan fingers, retinas or other biometric indicia to determine identity. The systems also include electronically controlled latches capable of opening to allow entry upon authorization. These systems are capable of limiting access based on identity and time and are far more configurable and controllable than basic security systems. They also, as a matter of course, create a record, called a “log,” of successful entries or failed attempts. The log may be reviewed to determine whether the premises are being adequately protected.

New laws have been enacted in the United States that set high privacy and access standards for confidential records. Such laws include the Health Insurance Portability and Accountability Act of 1996 (“HIPAA”) and the Sarbanes-Oxley Act of 2002 (colloqially referred to as “SOX”). Simple locks and keys are rarely adequate to fulfill the requirements of these new laws, and even modern, comprehensive, electronic security systems may provide insufficient information to comply with the new laws.

What is needed in the art is an improved security system. More specifically, what is needed in the art is a security system that collects and retains even more information regarding a requestor's attempt to gain entry to particular premises.

### SUMMARY OF THE INVENTION

To address the above-discussed deficiencies of the prior art, the present invention provides, in one aspect, a remote station for a security system. In one embodiment, the remote station includes: (1) a query unit configured to generate a query to a requestor (which may be a requestor or a thing) regarding a reason for an attempt by said requestor to gain entry to particular premises and (2) a response recorder associated with said query unit and configured to receive a response to said query and cause said response to be stored.

In another aspect, the present invention provides a method of providing security. In one embodiment, the method includes: (1) generating, with a query unit at a remote station, a query to a requestor regarding a reason for an attempt by the requestor to gain entry to particular premises, (2) receiving, with a response recorder at the remote station, a response to the query and (3) causing the response to be stored.

In yet another aspect, the present invention provides a security system. In one embodiment, the security system includes: (1) a remote station, including a reader/scanner, a query/response unit associated with the reader/scanner and configured to generate a query to a requestor regarding a reason for an attempt by the requestor to gain entry to particular premises and receive a response to the query and cause the response to be stored, and an access control device associated with the reader/scanner and (2) a central station, including: a permissions database configured to contain entry permissions data regarding the particular premises, a processor associated with the permissions database and configured to allow or deny the entry based on data received from the reader/scanner and the permissions database, and a logs database associated with the processor and configured to store at least some of the data received from the reader/scanner and record the response, the processor configured to allow the entry by activating the access control device.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a block diagram of one embodiment of a security system having an enhanced data-gathering capability and constructed according to the principles of the present invention; and

FIG. 2 illustrates a flow diagram of one embodiment of a method of providing security by means of enhanced data-gathering and carried out according to the principles of the present invention.

### DETAILED DESCRIPTION

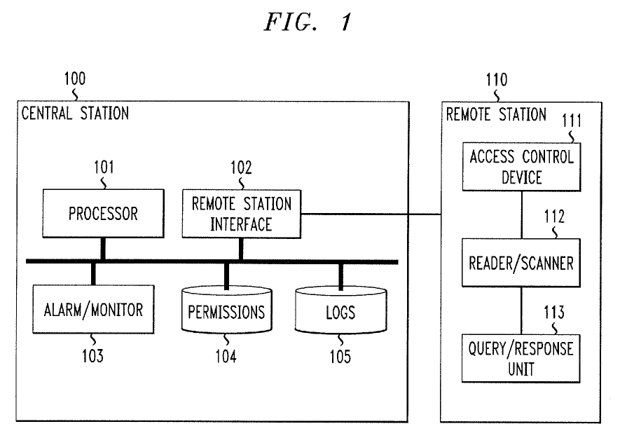

Referring initially to FIG. 1, illustrated is a block diagram of one embodiment of a security system. The security system includes a central station 100 and at least one remote station 110 and is constructed according to the principles of the present invention. In a manner that will be understood, the security system has an enhanced data-gathering capability. The illustrated embodiment gathers data regarding the identity of a requestor (who or what) entering a particular premises (where) through a particular door (how) at a certain time (when) for a given reason (why). The last datum represents valuable information and is neglected by conventional security systems.

The central station 100 is illustrated as including a processor 101. The processor 101 is configured to allow or deny entry based on data received from at least one reader/scanner and a permissions database to be described below. The central station 100 is also illustrated as including a remote station interface 102. The remote station interface 102 allows one or more remote stations (e.g., the remote station 110) to be coupled to the central station 100.

The central station 100 is further illustrated as including an alarm/monitor 103. The illustrated embodiment of the alarm/monitor 103 is configured to provide an alarm in the event that a requestor makes an attempt to gain access to particular premises but is denied that access by the security system. The illustrated embodiment of the alarm/monitor 103 is further configured to allow the status of the security system, including its various remote stations to be monitored by security personnel.

The central station 100 is also illustrated as including a permissions database 104. The permissions database 104 is configured to contain entry permissions data regarding the premises protected by the security system, including particular premises associated with the remote station 110. The permissions database 104 ostensibly contains a table of authorized requestors along with premises that they are authorized to enter, perhaps constrained to particular periods of time.

The central station 100 is further illustrated as including a logs database 105. The logs database 105 is configured to store at least some of the data received from one or more remote stations (e.g., the remote station 110). Of course, the permissions database 104 and the logs database 105 need not be stored on separate disk drives as FIG. 1 shows. FIG. 1 is merely an example of one central station architecture.

A bus (shown but not separately referenced) couples the processor 101, remote station interface 102, alarm/monitor 103, permissions database 104 and logs database 105. Those skilled in the pertinent art are familiar with conventional computer architectures in which busses are employed to join various system components or subsystems together. Those skilled in the pertinent art therefore understand that the central station 100 may be embodied in a conventional computer, such as a personal computer, provided with suitable software for enabling the various functions desired to be provided for a particular application. Finally, those skilled in the pertinent art understand that the present invention is not limited to a particular central station architecture.

The security system further includes at least one remote station, e.g., the remote station 110. The illustrated embodiment of the remote station 110 includes an access control device 111. The access control device 111 may be any conventional or later-developed device for opening particular premises for entry in response to a signal from a security system. For example, the access control device 111 may be an electric strike to allow a door to be opened or a motor to open a door or gate. Those skilled in the pertinent art should understand that the present invention is not restricted to a particular type of access control device.

The illustrated embodiment of the remote station 110 includes a reader/scanner 112. The reader/scanner 112 may be any conventional or later-developed device for ascertaining the identity of a requestor that wants or needs to gain entry to particular premises. For example, the reader/scanner 112 may be a magnetic card swipe reader, a proximity card reader, a radio frequency identification (RFID) tag reader, a fingerprint scanner or an iris scanner. Those skilled in the pertinent art should understand that the present invention is not restricted to a particular type of reader/scanner.

The illustrated embodiment of the remote station 110 includes a query/response unit 113. The query/response unit 113 is configured to generate a query to a requestor regarding a reason for an attempt by the requestor to gain entry to particular premises, receive a response to the query and cause the response to be stored. The query/response unit 113 may be an integrated unit or separate query and response units. In the latter case, the query unit is configured to generate the query, and the response unit is configured to receive the response and cause the response to be stored.

The query/response unit 113 may include a visual display (not shown) and may be configured to employ the visual display to display the query. In such case, the query is assumed to be visual. Alternatively, the query/response unit 113 may include a speaker (not shown), and may be configured to employ the speaker to reproduce the query. In such case, the query is assumed to be audible. Those skilled in the pertinent art will understand, however, that the query may take any form that can be perceived by a requestor requesting entry.

The query/response unit 113 may include a keyboard Not shown) and may be configured to employ the keyboard to receive the response. In such case, the response is assumed to be typewritten. Alternatively, the query/response unit 113 may include a microphone (not shown and may be configured to employ the microphone to receive the response. In such case, the response is assumed to be spoken. Those skilled in the pertinent art will understand, however, that the response may take any form that a requestor can generate to indicate his (or its) reason for requesting entry.

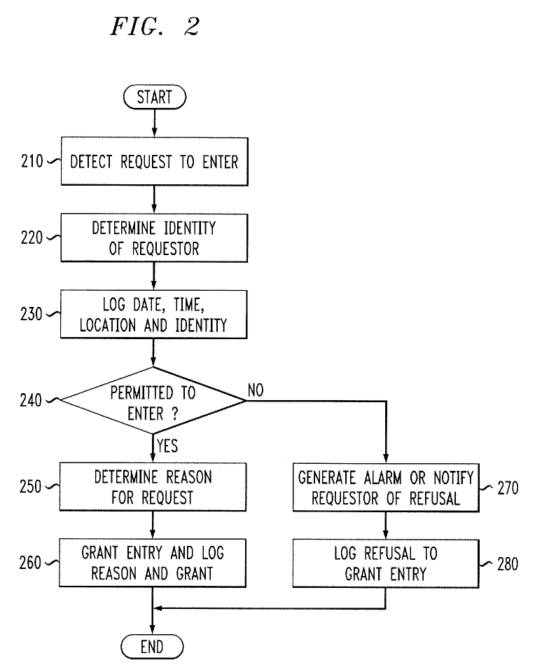

Having described the structure of one embodiment of a security system and a remote station constructed according to the present invention, attention will now be directed to one embodiment of a method of providing security. Accordingly, turning now to FIG. 2, illustrated is a flow diagram of one embodiment of a method of providing security by means of enhanced data-gathering and carried out according to the principles of the present invention.

The method begins in a start step (shown but not referenced). A request to enter is detected in a step 210. The step 210 may be performed, e.g., by means of a reader or scanner. The identity of the requestor is determined in a step 220. Again, a reader or scanner may be used to perform the step 220. The date, time, location and identity of the request and requestor are logged in a step 230. This may involve transmitting data to the logs database 105 of FIG. 1.

In a decisional step 240, it is determined whether the requestor is permitted to enter. This determination may involve the processor 101 and the permissions database 104 of FIG. 1. If it is determined that the requestor is permitted to enter, a reason for the request is ascertained in a step 250. The step 250 involves generating a query (e.g., by visual display, speaker or other means) to the requestor regarding a reason for an attempt by the requestor to gain entry to the particular premises and receiving a response (e.g., by keyboard, microphone or other means) to the query. Thus, the query/response unit 113 of FIG. 1 may be used to perform the step 250. Again, assuming that the requestor is permitted to enter, entry may be granted and the reason and existence of the grant logged in a step 260. The step 260 involve causing the response to be stored and involves may involve actuating the access control device 111 of FIG. 1 and transmitting the reason and the fact that the access control device 111 has been activated to the logs database 105 of FIG. 1.

If it is determined that the requestor is not permitted to enter and entry thereby refused, an alarm may be generated, the requestor may be notified of the refusal to grant entry or both in a step 270. The alarm/monitor 103 may be used to generate the alarm, and the query/response unit 113 may be used to notify the requestor. The refusal to grant entry is logged in a step 280. This may be performed by transmitting data to the logs database 105 of FIG. 1.

The steps of the method of FIG. 2 may be performed in other advantageous orders. For example, a query may be generated and a response received before determining whether the requestor is authorized to enter. In this way, a purported reason for requesting entry may be obtained for later analysis. Alternatively, entry may be allowed even to unauthorized requestors, but only for the purpose of causing them to believe that they have been successful in their attempt until security personnel arrive. The response generated by the requestor may be freeform or may be restricted to one or more selections from a menu of possible reasons for requesting entry. Those skilled in the pertinent art will understand and devise various alternative orders and embodiments that nonetheless fall within the broad scope of the present invention.

Although the present invention has been described in detail, those skilled in the pertinent art should understand that they can make various changes, substitutions and alterations herein without departing from the spirit and scope of the invention in its broadest form.

What is claimed is:

1. A remote station for a security system, comprising:
a query unit configured to generate a query to a requestor regarding a reason for an attempt by said requestor to gain entry to particular premises; and
a response recorder associated with said query unit and configured to receive a response to said query and cause said response to be stored.

2. The remote station as recited in claim 1 wherein said query unit comprises a visual display, said query being visual, said query unit configured to employ said visual display to display said query.

3. The remote station as recited in claim 1 wherein said query unit comprises a speaker, said query being audible, said query unit configured to employ said speaker to reproduce said query.

4. The remote station as recited in claim 1 wherein said response unit comprises a keyboard, said response being typewritten, said response unit configured to employ said keyboard to receive said response.

5. The remote station as recited in claim 1 wherein said response unit comprises a microphone, said response being spoken, said response unit configured to employ said microphone to receive said response.

6. The remote station as recited in claim 1 wherein said response unit is configured to record said response by transmitting said response to a central station.

7. The remote station as recited in claim 1 further comprising an access control device associated with said response unit and configured to allow said entry to said particular premises.

8. A method of providing security, comprising:
generating, with a query unit at a remote station, a query to a requestor regarding a reason for an attempt by said requestor to gain entry to particular premises;
receiving, with a response recorder at said remote station, a response to said query; and
causing said response to be stored.

9. The method as recited in claim 8 wherein said query unit comprises a visual display, said query being visual, said generating comprising employing said visual display to display said query.

10. The method as recited in claim 8 wherein said query unit comprises a speaker, said query being audible, said generating comprising employing said speaker to reproduce said query.

11. The method as recited in claim 8 wherein said response unit comprises a keyboard, said response being typewritten, said receiving comprising employing said keyboard to receive said response.

12. The method as recited in claim 8 wherein said response unit comprises a microphone, said response being spoken, said receiving comprising employing said microphone to receive said response.

13. The method as recited in claim 8 wherein said causing comprises transmitting said response to a central station.

14. The method as recited in claim 8 further comprising allowing, with an access control device at said remote station, said entry to said particular premises.

15. A security system, comprising:
a remote station, including a reader/scanner, a query/response unit associated with said reader/scanner and configured to generate a query to a requestor regarding a reason for an attempt by said requestor to gain entry to particular premises, receive a response to said query and cause said response to be stored, and an access control device associated with said reader/scanner; and
a central station, including: a permissions database configured to contain entry permissions data regarding said particular premises, a processor associated with said permissions database and configured to allow or deny said entry based on data received from said reader/scanner and said permissions database, and a logs database associated with said processor and configured to store at least some of said data received from said reader/scanner and record said response, said processor configured to allow said entry by activating said access control device.

16. The system as recited in claim 15 wherein said query/response unit comprises a visual display, said query being visual, said query/response unit configured to employ said visual display to display said query.

17. The system as recited in claim 15 wherein said query/response unit comprises a speaker, said query being audible, said query/response unit configured to employ said speaker to reproduce said query.

18. The system as recited in claim 15 wherein said query/response unit comprises a keyboard, said response being typewritten, said query/response unit configured to employ said keyboard to receive said response.

19. The system as recited in claim 15 wherein said query/response unit comprises a microphone, said response being spoken, said query/response unit configured to employ said microphone to receive said response.

20. The system as recited in claim 15 wherein said central station further includes an alarm/monitor associated with said processor.
